(19) United States
(12) Patent Application Publication
(10) Pub. No.: US 2020/0034910 A1
(43) Pub. Date: Jan. 30, 2020

(54) CUSTOMER INTERFACE FOR COORDINATED SERVICES

(71) Applicant: Walmart Apollo, LLC, Bentonville, AR (US)

(72) Inventors: Courtland J. Halbrook, Centerton, AR (US); Steven Ray Simpson, Bentonville, AR (US)

(21) Appl. No.: 16/516,004

(22) Filed: Jul. 18, 2019

Related U.S. Application Data
(60) Provisional application No. 62/711,552, filed on Jul. 29, 2018.

(51) Int. Cl. G06Q 30/06

(52) U.S. Cl. CPC G06Q 30/0631; G06Q 30/0645; G06Q 30/0641; G06Q 30/0633

(57) ABSTRACT

Systems and methods are disclosed for providing a customer interface for coordinated services that may use parameters of purchased or selected products to determine whether to recommend use of a delivery service or a professional service such as assembly, painting or other services. The disclosed interface provides a link between a retail shopping experience and an online e-commerce service, coordinating pick up, delivery, and professional service options and may include scheduling functionality. An interface display may comprise a virtual wall with multiple user interface (UI) display regions related to various aspects of a combined on-site and virtual shopping experience.

### BACKGROUND

Often, bulky or large items purchased at a retail location may not fit easily into a passenger car or are too heavy for the customer to lift. Additionally, some customers may be able to get products home only to find that additional tools and expertise are needed for assembly or use, such as assembling a grill or a swing set, or applying paint or yard treatments.

### SUMMARY

Systems and methods are disclosed for providing a customer interface for coordinated services that may use parameters of purchased or selected products to determine whether to recommend use of a delivery service or a professional service such as assembly, painting or other services. The disclosed interface provides a link between a retail shopping experience and an online e-commerce service, coordinating pick up, delivery, and professional service options and may include scheduling functionality. An interface display may comprise a virtual wall with multiple user interface (UI) display regions related to various aspects of a combined on-site and virtual shopping experience.

Some exemplary embodiments of a customer interface for coordinated services, implemented on at least one processor, may comprise: a display; a processor; and a non-transitory computer-readable medium storing instructions that are operative when executed by the processor to: responsive to an item being placed into a virtual shopping cart, determine parameters for the item related to transportability; determine whether the parameters for the item related to transportability indicate that delivery or vehicle rental may be needed; and responsive to determining that delivery or vehicle rental may be needed, generate a set of transportation options; display the set of generated transportation options on the display; receive a selection of a transportation option; and control the transportation option to perform a delivery of the item.

Some exemplary methods for providing a customer interface for coordinated services, implemented on at least one processor, may comprise: responsive to an item being placed into a virtual shopping cart, determining parameters for the item related to transportability; determining whether the parameters for the item related to transportability indicate that delivery or vehicle rental may be needed; and responsive to determining that delivery or vehicle rental may be needed, generating a set of transportation options; displaying the set of generated transportation options on a display; receiving a selection of a transportation option; and controlling the selected transportation option to perform a delivery of the item.

One or more exemplary computer storage devices having a first computer-executable instructions stored thereon for providing a customer interface for coordinated services, which, on execution by a computer, cause the computer to perform operations may comprise: responsive to an item being placed into a virtual shopping cart, determining parameters for the item related to transportability, wherein determining parameters for the item related to transportability comprises determining at least one selected from the list consisting of: dimensions of the item and weight of the item; determining whether the parameters for the item related to transportability indicate that delivery or vehicle rental may be needed; responsive to determining that delivery or vehicle rental may be needed, generating a set of transportation options; and displaying the set of generated transportation options on a display; determining parameters for the item related to assembly or application; determining whether the parameters for the item related to assembly or application indicate that professional services may be needed; and responsive to determining that professional services may be needed, generating a set of professional services recommendations; displaying the set of professional services recommendations on the display; receiving a selection of a transportation option; and controlling the selected transportation option to perform a delivery of the item.

Alternatively, or in addition to the other examples described herein, examples include any combination of the following: determining parameters for the item related to transportability comprises determining at least one selected from the list consisting of: dimensions of the item and weight of the item; determining whether the parameters for the item related to transportability indicate that delivery or vehicle rental may be needed comprises: determining customer automobile parameters; responsive to an item being placed into the virtual shopping cart, determine parameters for the item related to assembly or application; determine whether the parameters for the item related to assembly or application indicate that professional services may be needed; and responsive to determining that professional services may be needed, generate a set of professional services recommendations; and display the set of professional services recommendations on the display; responsive to an item being placed into the virtual shopping cart, determine whether the item is in stock at a first retail location; responsive to determining that the item is not in stock at the first retail location, performing an operation selected form the list consisting of: connect to an e-commerce service and determine whether the item is in stock at a second retail location; a sensor, coupled to the processor, and operable to identify a customer or a customer's device; and responsive to identifying a customer or a customer's device, retrieve a customer profile.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary environment which may advantageously employ embodiments of a customer interface for coordinated services.

FIG. 2 illustrates an exemplary networking and data storage arrangement which may be used with some embodiments.

FIG. 3 illustrates an exemplary kiosk for a customer interface for coordinated services.

FIG. 4 is an exemplary flow chart illustrating a process that may be used in conjunction with a customer interface for coordinated services.

FIG. 5 is another exemplary flow chart illustrating a process that may be used in conjunction with a customer interface for coordinated services.

FIG. 6 is an exemplary block diagram illustrating an operating environment for a computing device that may be used with or within embodiments disclosed herein.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

Systems and methods are disclosed for providing a customer interface for coordinated services that may use parameters of purchased or selected products to determine whether to recommend use of a delivery service or a professional service such as assembly, painting or other services. The disclosed interface provides a link between a retail shopping experience and an online e-commerce service, coordinating pick up, delivery, and professional service options and may include scheduling functionality. An interface display may comprise a virtual wall with multiple user interface (UI) display regions related to various aspects of a combined on-site and virtual shopping experience.

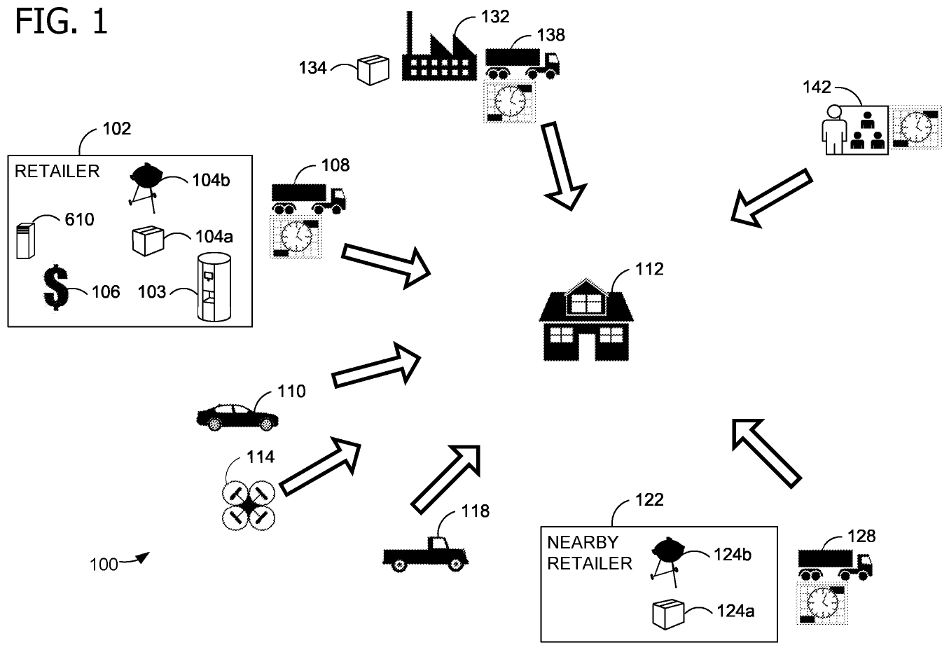

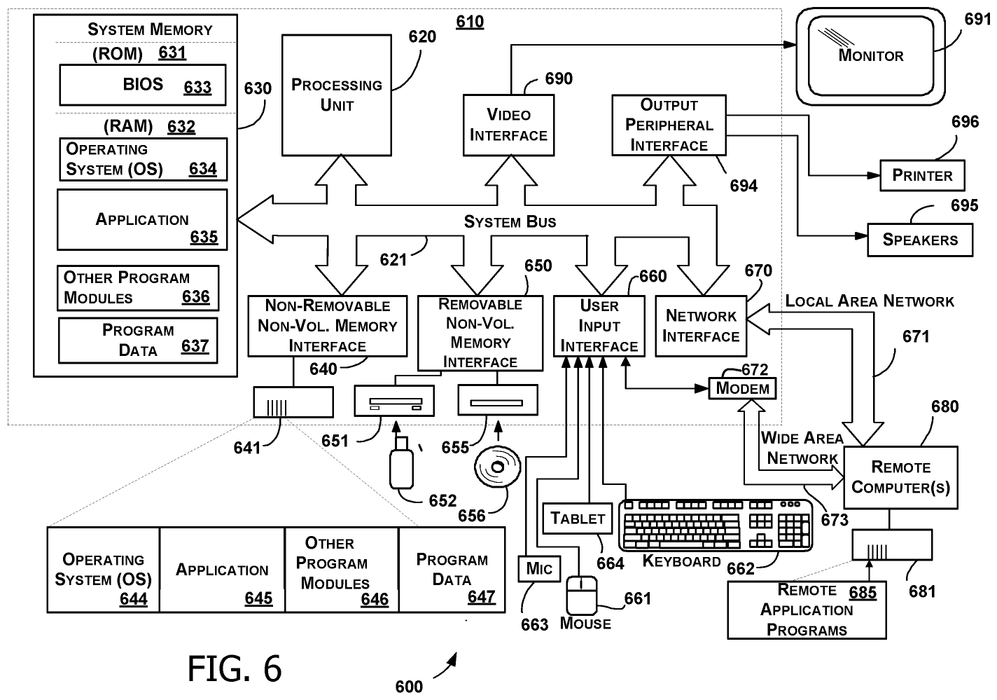

FIG. 1 illustrates an exemplary environment 100 which may advantageously employ embodiments of a customer interface for coordinated services. In environment 100, a customer desires to obtain a particular product and have it transported to the customer's residence 112. The customer goes to a first retailer 102, and uses a customer interface for coordinated services that runs, at least partially, on a computing node (computer) 610. Computer 610 will be described in more detail with reference to FIG. 6. The customer learns that the desired product is available on-site at retailer 102, both in boxed (packaged) condition 104a and as assembled 104b. The customer also learns, through the interface, that associated items are recommended for use with the particular product, as well as professional assembly assistance, and multiple transportation options. The customer is able to pay for the transaction, either with an on-site cahier, or through a point-of-sale 106 that is part of the customer interface for coordinated services. The payment may be for the particular product only, or may also include transportation and assembly services.

The customer then needs to have the purchased product transported to residence 112. It is possible that in packaged condition 104a, the product will fit in the customer's own automobile 110. If so, the customer may use that option. However, if the product is available as already assembled 104b, and will not fit within the customer's own automobile 110, the customer my use a rental truck 118 (or van, or other vehicle) or schedule a delivery service 108 for delivery from retailer 102 to residence 112. In some embodiments, the payment for rental truck 118 or delivery service 108 may be made with point-of-sale 106, and delivery service 108 may further be scheduled using the customer interface for coordinated services, at a time when the customer expects a person to be available at residence 112 to accept delivery.

In some embodiments, a customer interface for coordinated services may use product parameters, such as dimensions and weight in both boxed (packaged) condition 104a and as assembled 104b, along with knowledge of the cargo capacity of customer's automobile 110 to suggest delivery options. For example, if the customer indicates purchase of the product in boxed condition 104a, and the product in boxed condition 104a exceeds some threshold dimension or weight, the customer interface may suggest a delivery option for the product. Alternatively, some embodiments may prompt the customer to enter a description of customer's automobile 110, or pull a list of the customer's automobiles from a customer profile and request confirmation of the one used, and inform the customer if the product will not fit within customer's automobile 110. Some embodiments may suggest professional services 142 (which may include assembly and other professional services such as painting), and provide both for payment and scheduling of those services to go to residence 112.

For example, some embodiments of a customer interface for coordinated services may determine that packaged product 104a is too heavy for a single person to lift comfortably, prompt the user to schedule delivery service 108, and based upon the scheduled delivery, prompt the user to schedule professional services 142 to arrive after expected delivery to assemble packaged product 104a. As another example, if the customer identifies a preference for purchasing assembled product 104b, some embodiments of a customer interface for coordinated services may determine from the product parameters that assembled product 104b is too large for customer's automobile 110, but is not overly heavy, and may prompt the customer to use a rental truck 118 or another transportation option such as delivery service 108. As yet another example, if the customer will be purchasing packaged product 104a that includes some amount of paint (more than a threshold volume), some embodiments of a customer interface for coordinated services may prompt the customer to schedule painters through professional services 142, as well as permit the customer to pay for the entirety of the transaction (including professional services 142) through point-of-sale 106. And further, the customer interface for coordinated services may suggest related items, such as paint brushes and drop cloths, and add those items to the customer's shopping list.

In some situations, however, the customer's desired product, packaged product 104a or assembled product 104b, or a suggested related item is not available on-site (i.e., not in-stock, according to an inventory list accessed by the customer interface for coordinated services). If the desired product is available at a nearby retailer 122, such as packaged product 124a or assembled product 124b, the customer is notified. If, using the product parameters of dimensions and weight, and comparing that with the stated cargo capacity (dimensions and weight) in an customer automobile parameters database accessed by the customer interface, the customer may be prompted to schedule a delivery service 128 from nearby retailer 122 to residence 112, or even possibly retailer 102 for the customer to pick up at a later time. If the product is not too large or heavy, the customer may be provided a map to nearby retailer 122, and the products may be placed on hold for pick up, or the items may be delivered by a drone 114. Drone 114 may autonomous or semi-autonomous, and may be an unmanned aerial vehicle (UAV) or an unmanned ground vehicle (UGV). Some drones may be large enough to carry human passengers or tow a full size trailer. Alternatively, the customer's desired product may be most readily available from remote warehouse 132, as product 134, and so the customer may schedule delivery service 138 to deliver to either residence 112 or retailer 102 for later pick up (perhaps using an automated storage and retrieval system (ASRS) 103 located at retailer 102 or nearby retailer 122). Collectively, any of the delivery service 108 vehicles, ASRS 113, drone 114, and rental truck 118 may be referred to as a transportation option that may be controlled by a customer interface for coordinated services.

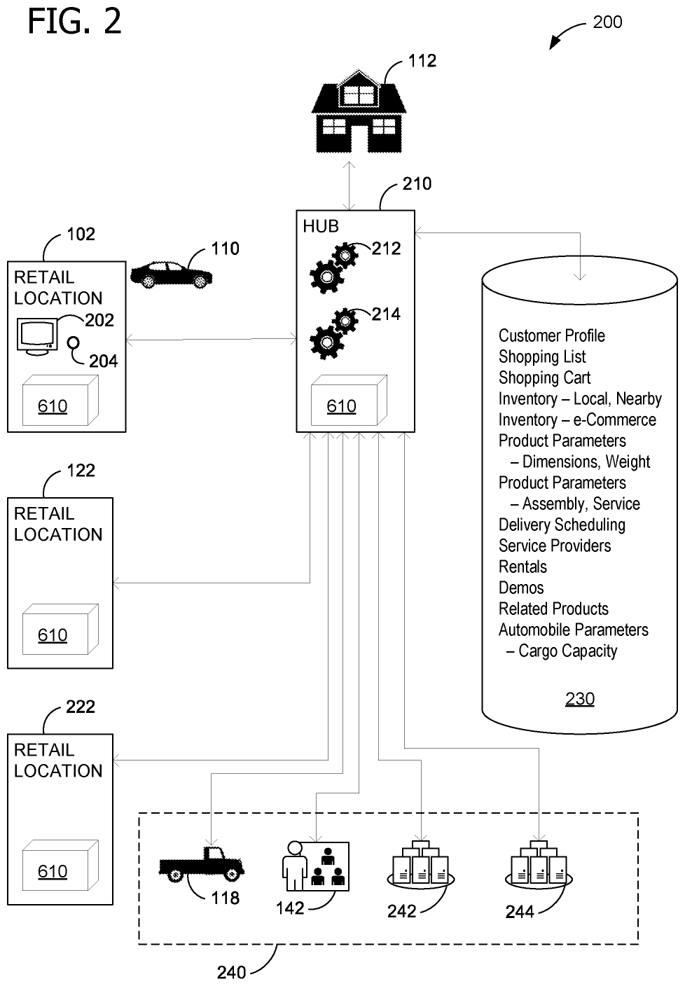

FIG. 2 illustrates an exemplary networking and data storage arrangement 200 which may be used with some embodiments. A customer may search for a particular product from residence 112, and a central hub 210 polls computing nodes 610 in each of retailer locations 102, 122, and 222, to determine whether the desired product is in stock. A customer interface for coordinated services management module 212 may, for example, use a set of databases 230 to search for in-stock inventory. As indicated, databases 230 include multiple sets of information that can be used by management module 212, including:

Customer Profiles;

Shopping Lists;

Shopping Cart;

Inventory—e-Commerce;

Product Parameters—Dimensions, Weight;

Product Parameters—Assembly, Service;

Delivery Scheduling;

Service Providers;

Rentals;

Demos;

Related Products; and

Automobile Parameters—Cargo Capacity.

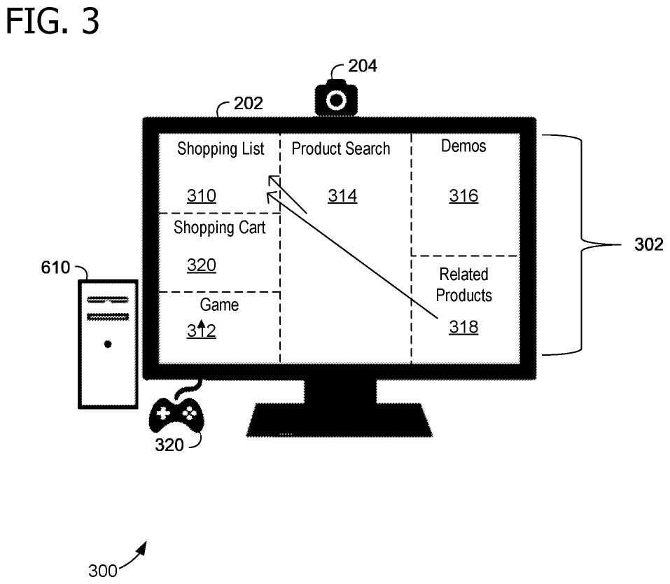

If a customer is already at retail location 102, the customer can go to a kiosk 300 (shown in FIG. 3) to interact with a display 202 for a customer interface for coordinated services. In some embodiments, a sensor 204 of the customer interface for coordinated services may permit automated log-in. Sensor 204 may be an eye scanner, fingerprint scanner, facial recognition device, gesture recognition device, or may recognize a customer's device, such as smartphone or a wearable device (perhaps a smart watch). Upon identification of the customer, management module 212 may retrieve the customer's profile and identify any open shopping list and show it on display 202. Management module 212 also interfaces with truck rental 118 (and other delivery services, such as delivery services 108, 128, and 138 of FIG. 1), professional services 142, an e-commerce service 242, and other data sources 244.

In an exemplary operation, a customer enters retail location 102, approaches display 202 and may by identified using sensor 204. Both display 202 and sensor 204 are coupled to computing node 610 in retail location 102. Computing node 610 in retail location 102 communicates with computing node 610 that may be running management module 212. Management module 212 access databases 230, either stored locally or remotely, to determine the identity of the customer and retrieve the customer's profile and any open shopping lists. Upon the customer indicating the desire to purchase a particular product, management module 212 determines whether it is in the inventory of the local retail location 102, and if the desired product is not in stock, management module 212 determines whether it is in the inventory of nearby retail location 122, and possibly also the inventory of e-commerce service 242. If the desired product is available on-site, management module 212 determines the product parameters, including dimension and weight, to identify options for transporting the product. Management module 212 may filter the options, based on the customer profile, and generate a list of selectable options on display 202. If the customer selects to use the customer's own automobile 110, management module 212 determines the customer automobile parameters, including cargo capacity, to further filter the list of selectable options. For example, if the product, or set of products being purchased together, are too large or heavy for the customer's own automobile 110, the list of selectable options on display 202 may be modified to suggest delivery, rather than self-carry, or to suggest the purchase be split into different options: self-carry some items and have others delivered.

Management module 212 determines the product parameters regarding assembly and other services, such as painting, planting, spreading or other activities involved with using some products, and may generate options for hiring service providers referenced in the list of qualified service providers in databases 230. Management module 212 may also determine whether videos or other instructions are available demonstrating use or operation of the product, such as a cooking video or printable recipe, assembly instructions, or application instructions, and display the videos (or perhaps static information) on display 202. Further, management module 212 may also consult the related products section of databases 230 to determine whether related products may be recommended and added to the customer's shopping list.

In some embodiments, management module 212 may comprise a machine learning module 214 to learn customer choices, including receiving feedback that certain items cannot fit within certain automobiles and noting items typically purchased together, and thus make improved recommendations for future customers, as time progresses. Machine learning module 214 may learn a particular customer's preferences, and make future recommendations tailored to that customer, and may also learn from aggregating customer choices among multiple customers.

FIG. 3 illustrates an exemplary kiosk 300 for a customer interface for coordinated services. Kiosk 300 may be located in the front of a retail location, such as nearby a customer service area, possibly within a cubicle for some degree of privacy. In some scenarios, such as two parents arriving with a child, one parent may shop, while the other remains at kiosk 300 with the child. As illustrated, kiosk 300 includes display 202, sensor 204, computing node 610, and a game controller 320. Display 202 may be a touchscreen display, or may be comprised of multiple separate display screens. Some embodiments of kiosk 300 may further include a keyboard, mouse, UPC barcode scanner, and other input or output devices for interacting with a customer, a customer's personal devices, or products.

As illustrated display 202 is being used as a “virtual wall” 302 for simultaneous display of multiple items. Virtual wall 302 provides multiple user interface (UI) display regions related to various aspects of a combined on-site and virtual shopping experience. These include a shopping list region 310, a game region 312, a product search region 314, a demo region 316, and a related products region 318. In operation, a customer's shopping list, retrieved as previously described, may be displayed in shopping list region 310. If the customer brought along a child, the child may be entertained by watching a sporting event or movie, or playing a video game in the game region 312, using game controller 320. The customer may then search for and learn about products in product search region 314, which may access databases 230 to determine inventory availability, and may also access e-commerce service 242. If a customer locates a desired product in product search region 314, then in some embodiments, a swiping or drag-and-drop action may copy that product over to the shopping list displayed in shopping list region 310. When the customer decides to obtain a particular product it may be moved into a virtual shopping cart 320. Some embodiments of a kiosk may have a printer to print out a list of the shopping cart items that are in stock at the retail location, and available for pick up. A copy of the customer's shopping lists and virtual shopping cart may be updated in databases 230 (of FIG. 2).

Product information, such as recipes and instructions, or demonstration videos that appear in demo region 316, may pull information from the Demos section of databases 230 or from other data sources 244. (See FIG. 2.) Products that are often purchased together, possibly as indicated by machine learning application to prior customers' shopping, or by a recommendation from a knowledgeable editor, may be identified in related products region 318. Transportation options, such as delivery options and scheduling, or truck rentals, and even customer profile edits may be accomplished using virtual wall 302, possibly using a new region, or by superseding the display of one of the enumerated regions, such as related products region 318. In some embodiments, display 202 and sensor 204 may be used to enable a video conference with a service professional (for obtaining advice and service quotes) or delivery manager, or another person who is actively shopping.

As another exemplary operation, for some embodiments, shopping list region 310 may have a series of bins representing different delivery options, and perhaps even different delivery times. For example, a customer may schedule delivery of an unassembled fertilizer spreader on a first date, and then delivery of fertilizer to be applied to a lawn, at a later date after time has elapsed to permit the customer to assemble the spreader. Deliveries and service professional appointments may be synchronized with a calendar on a customer's personal device, such as by using a calendar invitation. Specific delivery option bins may include.:

Pick up in store (during the current visit);

Delivery to residence at a particular date and time;

Delivery to store, for later assisted pick up;

Delivery to an ASRS for later self pick up; and

Delivery to some other specified location (office building, Post Office).

Some embodiments may further solicit bids from multiple pre-approved service vendors, and recommend from the responses, to add value for the customer. For example, the customer may be purchasing a tree, but the customer profile indicates that the customer has only sedans. The height of the tree may result in a flag for the customer interface for coordinated services to recommend a truck rental, and then requests bids from multiple tree planting services, to find one that can arrive in a timely manner and plant the tree for a preferable cost. In such an example operation, the customer interface for coordinated services is acting in the capacity of a broker—soliciting bids and making recommendations, so that the customer needs only a single source and a single transaction to accomplish their purchase and arrange for necessary associated services from among potentially multiple service providers. This may be further enhanced, in some embodiments, to act as a form of a concierge service, by taking into account a service provider's financial rating and service rating history from prior customers. In some situations, financing may be offered to the customer, if the purchase price exceeds some threshold, and the customer profile indicates financing is a possibility.

In some scenarios, kiosk 300 may provide a unique value to a customer shopping at a retail location in person, rather than shopping only online, such as providing instant coupons (with the offerings possibly tailored according to a customer profile indicating interests and past purchases). Even if kiosk 300 accesses an e-commerce service associated with the retailer, a link may be created between the physical retail location and the merchant's combined businesses (retail locations and e-commerce). For example, a bundling discount may be offered for purchasing a set of multiple items, some of which may be in inventory on-site at the retailer location and some of which are available only through delivery form an e-commerce service.

In some embodiments, if two customers arrived together, kiosk 300 may provide for communication between the customer located at kiosk 300 and the other shopping customer, possibly using cellular, Wi-Fi, or some other wireless access. During such communication, shopping lists could be exchanged and updated, and items on the shopping lists could be shifted from in-store pick up to delivery from an e-commerce service, in the event that a certain product was out of stock or for another reason. In some embodiments, the customer located at kiosk 300 may be able to locate the other shopping customer in a map of the retail facility, shown on display 202, possibly using wireless sensors on a physical shopping cart. Sensors on or nearby the physical shopping cart may even identify which items on a shopping list had already been collected. Items purchased together, whether picked up from in stock merchandise, or purchased from an e-commerce service, may be combined for shopping rewards programs or other bundling discounts.

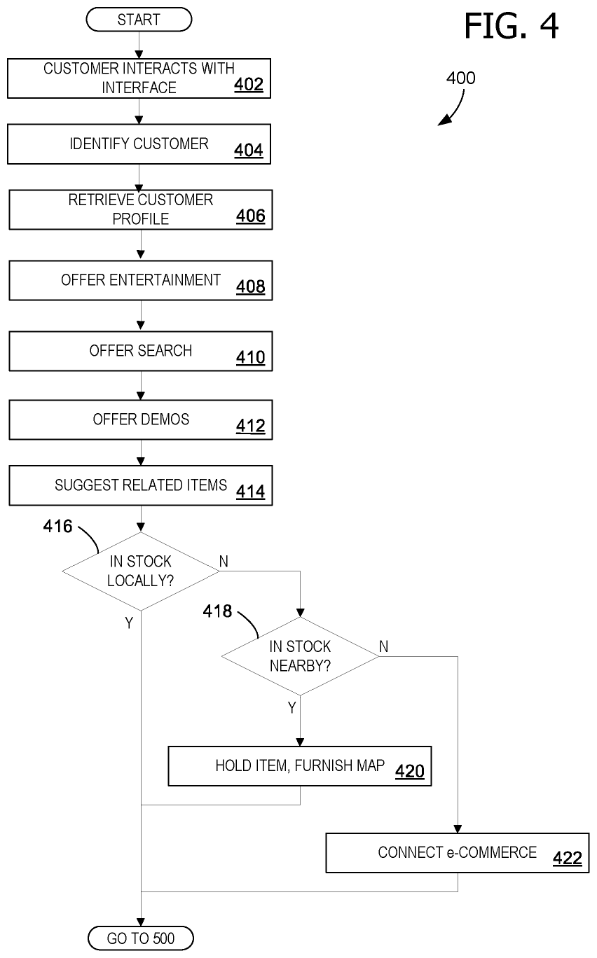

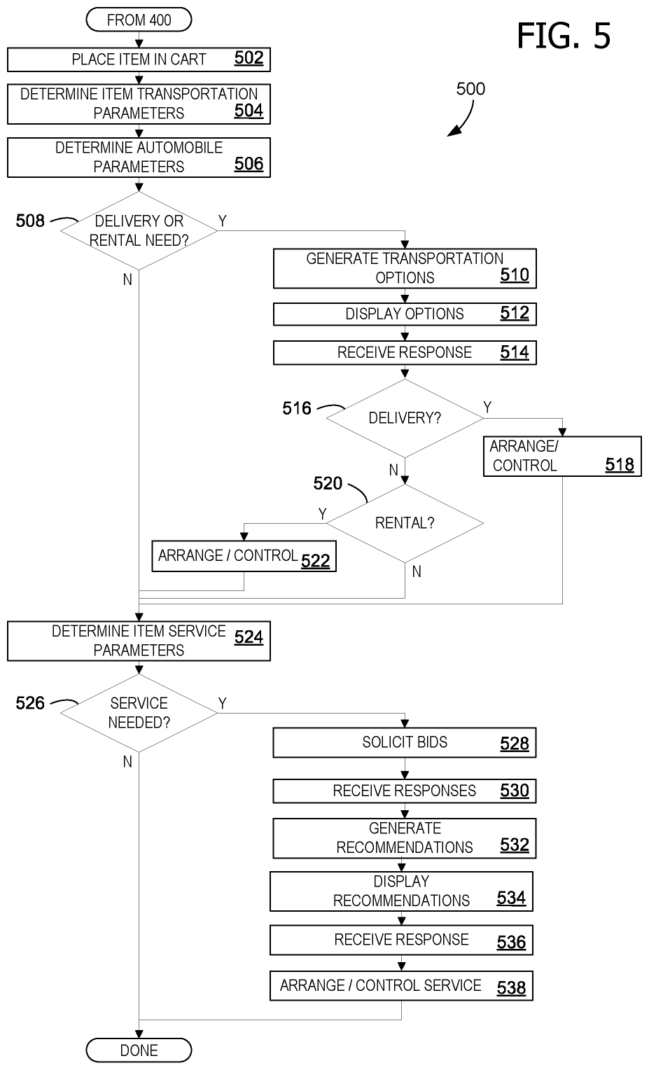

FIG. 4 is an exemplary flow chart 400 illustrating a process that may be used in conjunction with a customer interface for coordinated services. In some embodiments, flow chart 400 immediately precedes flow chart 500 (of FIG. 5), as a single process. A customer begins interacting with a customer interface for coordinated services, in operation 402, possibly by logging in or interacting with a display or a sensor, or having the customer's device (such as a smartphone or wearable device) interact with a sensor. See the description of FIG. 2, regarding a user interacting with display 202 and sensor 204. The customer is identified in operation 404, based on the interaction, and the customer profile is retrieved in operation 406. Shopping lists may also be retrieved in operation 406.

In operation 408, entertainment may be offered, such as a video game, a video to watch or perhaps display of live television or a sporting event. A product or service search capability is offered 410, and when a particular product or service is identified, demonstrations or instructions may be offered in operation 412. Related items may also be suggested in operation 414. These offerings and suggestions may be displayed in virtual wall 302, displayed on display 202 (see FIG. 3). Display 202 may permit interaction with the search capability, lists, and demos using a touchscreen interface.

The availability of an item in the local retail location is determined in decision operation 416, which determines whether an item is in stock locally. If it is not, then decision operation 418 determines whether the item is in stock in a nearby retail location. If it is available for pick up nearby, then operation 420 may place a hold on the item at the other retail location, and furnish the customer with a map and the address for the nearby retail location. If the item is not available for pickup, however, operation 422 connects the customer interface with an e-commerce service.

FIG. 5 is another exemplary flow chart 500 illustrating a process that may be used in conjunction with a customer interface for coordinated services. In some embodiments, flow chart 500 follows flow chart 400 (of FIG. 4), as a single process. When a customer places item in a virtual shopping cart (such as shopping cart 320 of FIG. 3) in operation 502, such as by a drag-and-drop procedure on a touchscreen interface of display 202, or a mouse operation, or some other procedure, item parameters related to transportation and transportability are determined in operation 504. This may include looking up item packaging information, including dimensions and weight. Such information can be used to ascertain whether the item can fit within certain vehicles, or may be too heavy for some people to lift alone.

Some embodiments may use information about the customer's vehicle, so operation 506 determines the customer's automobile parameters. This may include looking up a list of the customer's vehicles in the customer profile, and prompting for confirmation that one of those s present, or possibly by requesting the customer enter the information into the interface. Using the item parameters, and possibly the customer's automobile parameters, decision operation 508 determines whether delivery and/or a vehicle (truck or van) rental may be needed. This may involve comparing dimensions and weight to some threshold amounts. In some embodiments, the aggregate of multiple items are compared to threshold amounts of weight, maximum dimensions, and total calculated volume. This is because, even if each individual item may fit within the customer's automobile, the entire set of the items being picked up may exceed the automobile's cargo capacity. In some situations, if the customer had arrived by walking or riding a bicycle, a vehicle as small as a sedan may be satisfactory for a vehicle rental. Responsive to determining that delivery or a vehicle rental may be needed, a set of transportation options is generated in operation 510. The transportation options are displayed 512 and a response is received 514 with a selection of a transportation option from the customer. If delivery is indicated 516, then it is arranged in operation 518 with an instruction effectively controlling the selected transportation option to perform a delivery of the item. For delivery service 108, the control activity may include sending a manifest and delivery order over a network, whereas for drone 114 (see FIG. 1), the control activity may involve transmitting tasking, flight, destination, and loading/unloading commands.

Arranging delivery may include scheduling for a specific date and time, and synchronizing the selected time with a calendar on the customer's personal device. For example, a calendar invite may be emailed to the customer, using an email address in the customer profile, or perhaps by sending a text message (SMS). If a vehicle rental is indicated 520, then it is arranged in operation 522 with an instruction effectively controlling the selected transportation option to perform a delivery of the item. For a rental truck 118, the control activity may include sending a reservation request and mileage estimate over a network.

Either of operation 518 and 522 may include adding the cost of delivery or rental to the customer's shopping cart, so that the customer needs to pay only a single time. In some embodiments, tool rentals may also be suggested and included in operations 508, 520 and 522. Additionally, operation 518 and 522 may include controlling ASRS 103 (of FIG. 103) to perform a delivery of the item to whomever is to retrieve it (the customer with automobile 110 or rental vehicle 118, delivery service 108 personnel, or drone 114).

In operation 524 parameters for the item related to services, such as assembly or application, are determined. This may include whether the item requires assembly, or whether the item is associated with services. Items associated with services include paint (applied by painters), trees (planted by gardeners), fertilizer (spread by gardeners), and other items. If service is needed, according to decision operation 526, then operation 528 solicits bids, perhaps from multiple pre-approved service providers. The service providers respond and responses are received 530. Operation 532 generates a set of professional services recommendations. This may include evaluating a service provider's financial rating and service rating history from prior customers. Effectively, this provides a form of a concierge service, because the customer needs only a single source and a single transaction to accomplish their purchase and arrange for necessary associated services from among potentially multiple service providers.

The set of professional services recommendations are displayed 534 (such as on display 202 of FIG. 3) and the customer's selection is received as a response in operation 536. Any requested services are arranged or controlled in operation 538, possibly including making reservations or sending instructions over a network. This may include, for example, specifying assembly of an item at the retail location, such as a bicycle, so the item can be picked up assembled, or arranging for assembly services at the customer's residence or other location. Similarly with delivery services, arranging services may include scheduling for a specific date and time, and synchronizing the selected time with a calendar on the customer's personal device. Additionally, arranging services in operation 538 may include paying for the services in a single transaction with purchasing the item.

### Exemplary Operating Environment

FIG. 6 is an exemplary block diagram illustrating an operating environment 600 for a computing device that may be used with or within embodiments disclosed herein. The computing system environment (operating environment) 600 is only one example of a suitable computing environment and is not intended to suggest any limitation as to the scope of use or functionality of the disclosure. Neither should the computing environment 600 be interpreted as having any dependency or requirement relating to any one or combination of components illustrated in the exemplary operating environment 600. The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 6, an exemplary system for implementing various aspects of the disclosure may include a general purpose computing device in the form of a computing node (computer) 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media may be any available media that may be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 631 and 632 are examples of non-transitory computer-readable storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 610. Computer storage media does not, however, include propagated signals. Rather, computer storage media excludes propagated signals. Any such computer storage media may be part of computer 610.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs, such as an application 635 that may perform operations described herein, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a universal serial bus (USB) port 651 that provides for reads from or writes to a removable, nonvolatile memory 652, and an optical disk drive 655 that reads from or writes to a removable, nonvolatile optical disk 656 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and USB port 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, an application 645 that may perform operations described herein, other program modules 646 and program data 647. Note that these components may either be the same as or different from operating system 634, optimization environment 635, other program modules 636, and program data 637. Operating system 644, optimization environment 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel may be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

### Exemplary Operating Methods and Systems

An exemplary customer interface for coordinated services, implemented on at least one processor, may comprise: a display; a processor; and a non-transitory computer-readable medium storing instructions that are operative when executed by the processor to: responsive to an item being placed into a virtual shopping cart, determine parameters for the item related to transportability; determine whether the parameters for the item related to transportability indicate that delivery or vehicle rental may be needed; and responsive to determining that delivery or vehicle rental may be needed, generate a set of transportation options; display the set of generated transportation options on the display; receive a selection of a transportation option; and control the transportation option to perform a delivery of the item.

An exemplary method for providing a customer interface for coordinated services, implemented on at least one processor, may comprise: responsive to an item being placed into a virtual shopping cart, determining parameters for the item related to transportability; determining whether the parameters for the item related to transportability indicate that delivery or vehicle rental may be needed; and responsive to determining that delivery or vehicle rental may be needed, generating a set of transportation options; displaying the set of generated transportation options on a display; receiving a selection of a transportation option; and controlling the selected transportation option to perform a delivery of the item.

One or more exemplary computer storage devices having a first computer-executable instructions stored thereon for providing a customer interface for coordinated services, which, on execution by a computer, cause the computer to perform operations may comprise: responsive to an item being placed into a virtual shopping cart, determining parameters for the item related to transportability, wherein determining parameters for the item related to transportability comprises determining at least one selected from the list consisting of: dimensions of the item and weight of the item; determining whether the parameters for the item related to transportability indicate that delivery or vehicle rental may be needed; responsive to determining that delivery or vehicle rental may be needed, generating a set of transportation options; and displaying the set of generated transportation options on a display; determining parameters for the item related to assembly or application; determining whether the parameters for the item related to assembly or application indicate that professional services may be needed; and responsive to determining that professional services may be needed, generating a set of professional services recommendations; displaying the set of professional services recommendations on the display; receiving a selection of a transportation option; and controlling the selected transportation option to perform a delivery of the item.

A customer interface for coordinated services, implemented on at least one processor, may comprise: a processor; and a non-transitory computer-readable medium storing instructions that are operative when executed by the processor, the instructions comprising logic for implementing any of the methods or processes disclosed herein.

Alternatively, or in addition to the other examples described herein, examples include any combination of the following:
determining parameters for the item related to transportability comprises determining at least one selected from the list consisting of: dimensions of the item and weight of the item;
determining whether the parameters for the item related to transportability indicate that delivery or vehicle rental may be needed comprises: determining customer automobile parameters;
responsive to an item being placed into the virtual shopping cart, determine parameters for the item related to assembly or application;
determine whether the parameters for the item related to assembly or application indicate that professional services may be needed;
responsive to determining that professional services may be needed, generate a set of professional services recommendations;
display the set of professional services recommendations on the display;
responsive to an item being placed into the virtual shopping cart, determine whether the item is in stock at a first retail location;
responsive to determining that the item is not in stock at the first retail location, performing an operation selected form the list consisting of: connect to an e-commerce service and determine whether the item is in stock at a second retail location;
a sensor, coupled to the processor, and operable to identify a customer or a customer's device;
responsive to identifying a customer or a customer's device, retrieve a customer profile.

The examples illustrated and described herein as well as examples not specifically described herein but within the scope of aspects of the disclosure constitute an exemplary entity-specific value optimization environment. The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A customer interface for coordinated services, implemented on at least one processor, the interface comprising:
a display;
a processor;
a non-transitory computer-readable medium storing instructions that are operative when executed by the processor to:
responsive to an item being placed into a virtual shopping cart, determine parameters for the item related to transportability;
determine whether the parameters for the item related to transportability indicate that delivery or vehicle rental may be needed; and
responsive to determining that delivery or vehicle rental may be needed,
generate a set of transportation options;
display the set of generated transportation options on the display;
receive a selection of a transportation option; and
control the transportation option to perform a delivery of the item.

2. The customer interface of claim 1 wherein determining parameters for the item related to transportability comprises determining at least one selected from the list consisting of:
dimensions of the item and weight of the item.

3. The customer interface of claim 1 wherein determining whether the parameters for the item related to transportability indicate that delivery or vehicle rental may be needed comprises:
determining customer automobile parameters.

4. The customer interface of claim 1 wherein the instructions are further operative to:
responsive to an item being placed into the virtual shopping cart, determine parameters for the item related to assembly or application;
determine whether the parameters for the item related to assembly or application indicate that professional services may be needed; and
responsive to determining that professional services may be needed, generate a set of professional services recommendations; and
display the set of professional services recommendations on the display.

5. The customer interface of claim 1 wherein the instructions are further operative to:
responsive to an item being placed into the virtual shopping cart, determine whether the item is in stock at a first retail location.

6. The customer interface of claim 5 wherein the instructions are further operative to:
responsive to determining that the item is not in stock at the first retail location, performing an operation selected form the list consisting of:
connect to an e-commerce service and determine whether the item is in stock at a second retail location.

7. The customer interface of claim 1 further comprising:
a sensor, coupled to the processor, and operable to identify a customer or a customer's device.

8. The customer interface of claim 7 wherein the instructions are further operative to:
responsive to identifying a customer or a customer's device, retrieve a customer profile.

9. A method for providing a customer interface for coordinated services, implemented on at least one processor, the method comprising:
responsive to an item being placed into a virtual shopping cart, determining parameters for the item related to transportability;
determining whether the parameters for the item related to transportability indicate that delivery or vehicle rental may be needed; and
responsive to determining that delivery or vehicle rental may be needed,
generating a set of transportation options;
displaying the set of generated transportation options on a display;
receiving a selection of a transportation option; and
controlling the selected transportation option to perform a delivery of the item.

10. The method of claim 9 wherein determining parameters for the item related to transportability comprises determining at least one selected from the list consisting of:
dimensions of the item and weight of the item.

11. The method of claim 9 wherein determining whether the parameters for the item related to transportability indicate that delivery or vehicle rental may be needed comprises:
determining customer automobile parameters.

12. The method of claim 9 further comprising:
responsive to an item being placed into the virtual shopping cart, determining parameters for the item related to assembly or application;
determining whether the parameters for the item related to assembly or application indicate that professional services may be needed; and
responsive to determining that professional services may be needed, generating a set of professional services recommendations; and
displaying the set of professional services recommendations on the display.

13. The method of claim 9 further comprising:
responsive to an item being placed into the virtual shopping cart, determining whether the item is in stock at a first retail location.

14. The method of claim 13 further comprising:
responsive to determining that the item is not in stock at the first retail location, performing an operation selected form the list consisting of:
connecting to an e-commerce service and determining whether the item is in stock at a second retail location.

15. The method of claim 9 further comprising:
responsive to identifying a customer or a customer's device, retrieving a customer profile.

16. One or more computer storage devices having a first computer-executable instructions stored thereon for providing a customer interface for coordinated services, which, on execution by a computer, cause the computer to perform operations comprising:
responsive to an item being placed into a virtual shopping cart,
determining parameters for the item related to transportability, wherein determining parameters for the item related to transportability comprises
determining at least one selected from the list consisting of:
dimensions of the item and weight of the item;
determining whether the parameters for the item related to transportability indicate that delivery or vehicle rental may be needed;
responsive to determining that delivery or vehicle rental may be needed,
generating a set of transportation options; and
displaying the set of generated transportation options on a display;
determining parameters for the item related to assembly or application;
determining whether the parameters for the item related to assembly or application indicate that professional services may be needed; and
responsive to determining that professional services may be needed,
generating a set of professional services recommendations;
displaying the set of professional services recommendations on the display;
receiving a selection of a transportation option; and
controlling the selected transportation option to perform a delivery of the item.

17. The one or more computer storage devices of claim 16 wherein determining whether the parameters for the item related to transportability indicate that delivery or vehicle rental may be needed comprises:
determining customer automobile parameters.

18. The one or more computer storage devices of claim 16 further comprising:
responsive to an item being placed into the virtual shopping cart, determining whether the item is in stock at a first retail location.

19. The one or more computer storage devices of claim 20 further comprising:
responsive to determining that the item is not in stock at the first retail location, performing an operation selected form the list consisting of:
connecting to an e-commerce service and determining whether the item is in stock at a second retail location.

20. The one or more computer storage devices of claim 16 further comprising:
responsive to identifying a customer or a customer's device, retrieving a customer profile.
